(19) United States
(12) Patent Application Publication
(10) Pub. No.: US 2009/0190433 A1
(43) Pub. Date: Jul. 30, 2009

(54) Apparatus fro mixing salt with a liquid to generate a salt slurry

(76) Inventor: Kevin J. Davis, Orangeville, IL (US)

Correspondence Address: DAVID J. ARCHER, 7037 POMERY ROAD, ROCKTON, IL, 61072, US

(21) Appl. No.: 12/291,497

(22) Filed: Nov. 10, 2008

Related U.S. Application Data
(60) Provisional application No. 61/005,403, filed on Dec. 5, 2007.

(51) Int. Cl. B29B 7/72

(52) U.S. Cl. 366/131

(57) ABSTRACT

An apparatus is disclosed for mixing salt with a liquid to generate a salt slurry for spreading on a road surface for snow and ice control. The apparatus includes a chute having an inlet and an outlet, the inlet receiving therein the salt. The chute defines a passageway which is disposed between the inlet and the outlet. A first roller is disposed adjacent to the outlet of the chute, the first roller having an axis of rotation and a first and a second end. A second roller has a first and second extremity, the second roller being disposed adjacent to the outlet of the chute. The second roller has a rotational axis which is disposed parallel to the axis of rotation of the first roller. The rollers cooperate with each other so that the chute guides the salt between the rollers. An arrangement is provided for rotating the rollers relative to each other such that when the salt is guided between the rotating rollers, crushing of the salt is permitted. Also, a device is provided for selectively moving the axes of the rollers towards and away from each other such that when the rollers are rotated relative to each other, the crushing of the salt is controlled. A control device selectively controls a flow of the liquid into the chute so that the liquid mixes with the salt for generating the salt slurry. A rotatable spinner is disposed below the rollers for receiving and spreading the generated salt slurry on the road surface.

### CROSS REFERENCE TO RELATED APPLICATION

The present application is a Complete application filed pursuant to a Provisional application U.S. Ser. No. 61/005,403 filed Dec. 5, 2007. All of the disclosure of the aforementioned U.S. Ser. No. 61/005,403 is incorporated herein by reference.

### BACKGROUND OF THE INVENTION

1. Field of the Invention

The present invention relates to an apparatus for mixing salt with a liquid to generate a salt slurry. More specifically, the present invention relates to an apparatus for mixing salt with a liquid to generate a salt slurry for spreading on a road surface for snow and ice control.

2. Background Information

In the control of highway snow and ice there is a trend towards being able to apply more liquid and less salt. In order to achieve this objective, the present invention provides an apparatus that will crush standard rock salt that is commonly used on the highway for snow and ice control and also introduce enough liquid to create a salt slurry in a 70 percent liquid to a 30 percent granular mixture. This 70/30 percent mixture is adjustable through an electronic control. The salt slurry will be distributed on the roadway through a speed adjustable spinner.

The apparatus according to the invention has the ability to crush the salt with the use of two rollers of the type that is commonly used in a roller mill. The rollers are disposed in an enclosed chute and one of the rollers is adjusted towards and away from the other roller by an air cylinder. This gives the operator the option to crush the salt or spread the granular salt in it's normal uncrushed form. Crushing the salt to a finer grade, allows the brine process required to melt ice and snow, to start faster. Also it provides more granular particles providing a more even application of salt per lane mile.

Liquid application can be introduced above and below the rollers to achieve the optimum liquid to granular percentage.

The great advantage of the apparatus according to the present invention is that the apparatus can be mounted on a snow and ice control vehicle.

Therefore, the primary feature of the present invention is the provision of an apparatus for mixing salt with a liquid to generate a salt slurry that overcomes the problems associated with the prior art installations

Another feature of the present invention is the provision of an apparatus for mixing salt with a liquid to generate a salt slurry with the apparatus mounted onboard a highway snow and ice control vehicle.

Other features and advantages of the present invention will be readily apparent to those skilled in the art by a consideration of the detailed description of a preferred embodiment of the present invention contained herein.

### SUMMARY OF THE INVENTION

The present invention relates to an apparatus for mixing salt with a liquid to generate a salt slurry for spreading on a road surface for snow and ice control. The apparatus includes a chute having an inlet and an outlet, the inlet receiving therein the salt. The chute defines a passageway which is disposed between the inlet and the outlet. A first roller is disposed adjacent to the outlet of the chute, the first roller having an axis of rotation and a first and a second end. A second roller has a first and second extremity, the second roller being disposed adjacent to the outlet of the chute. The second roller has a rotational axis which is disposed parallel to the axis of rotation of the first roller. The rollers cooperate with each other so that the chute guides the salt between the rollers. An arrangement is provided for rotating the rollers relative to each other such that when the salt is guided between the rotating rollers, crushing of the salt is permitted. Also, a device is provided for selectively moving the axes of the rollers towards and away from each other such that when the rollers are rotated relative to each other, the degree of crushing of the salt is controlled. A control device selectively controls a flow of the liquid into the chute so that the liquid mixes with the salt for generating the salt slurry. A rotatable spinner is disposed below the rollers for receiving and spreading the generated salt slurry on the road surface.

In a more specific embodiment of the present invention, an arm is provided for removably securing the apparatus to a snow and ice control vehicle.

Also, the passageway is of rectangular cross-sectional configuration.

Furthermore, the first roller has a peripheral surface which extends between the first and second end of the first roller. The surface defines a plurality of serrations which extend parallel to the axis of rotation.

Additionally, the first end of the first roller defines a first journal and the second end of the first roller defines a second journal. A frame has a first and second termination, the first termination rotatably supporting the first journal while the second termination rotatably supports the second journal.

An actuator extends between the frame and the chute for controllably moving the frame and the first roller which is rotatably supported by the frame, relative to the second roller.

Also, the frame is of U-shaped configuration. The frame includes a first arm which has the first termination and an extension. A second arm has the second termination and a further extension. A cross-member has a first and a second end, the first end of the cross-member being secured to the extension. The second end of the cross-member is secured to the further extension.

The actuator has a first and a second extremity. The first extremity of the actuator is secured to the chute and the second extremity of the actuator is secured to the cross member between the ends thereof.

In a preferred embodiment of the present invention, the actuator is an air cylinder.

The arrangement for rotating the rollers includes a first motor which is connected to the first roller for rotating the first roller about the axis of rotation.

Moreover, a second motor is connected to the second roller for rotating the second roller about the rotational axis.

The first and second motors are arranged such that the first roller rotates slightly faster than the second roller.

Furthermore, the rollers counter-rotate relative to each other.

The control device for selectively controlling the flow of the liquid into the chute is a valve which is disposed between a source of the liquid and the chute so that a flow of the liquid into the chute for mixing thereof with the salt is controlled.

Also, the spinner includes a rotatable slurry dispenser. A drive is drivingly connected to the dispenser for rotating the dispenser.

A support is secured to the chute for supporting the drive and the dispenser.

Moreover, an adjuster is disposed between the support and the drive such that controlled movement of the dispenser relative to the chute is permitted so that a spread pattern of the salt slurry dispensed by the dispenser is attained.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a perspective view of an apparatus according to the present invention for mixing salt with a liquid to generate a salt slurry for spreading on a road surface for snow and ice control;

FIG. 2 is a side elevational view partially in section of the apparatus shown in FIG. 1;

FIG. 3 is a top plan view partially in section of the apparatus shown in FIGS. 1 and 2;

FIG. 4 is a similar view to that shown in FIG. 3 but shows the rollers moved towards each other; and

FIG. 5 is a similar view to that shown in FIG. 2 but shows the rollers moved away from each other.

Similar reference characters refer to similar parts throughout the various views of the drawings.

### DETAILED DESCRIPTION OF THE DRAWINGS

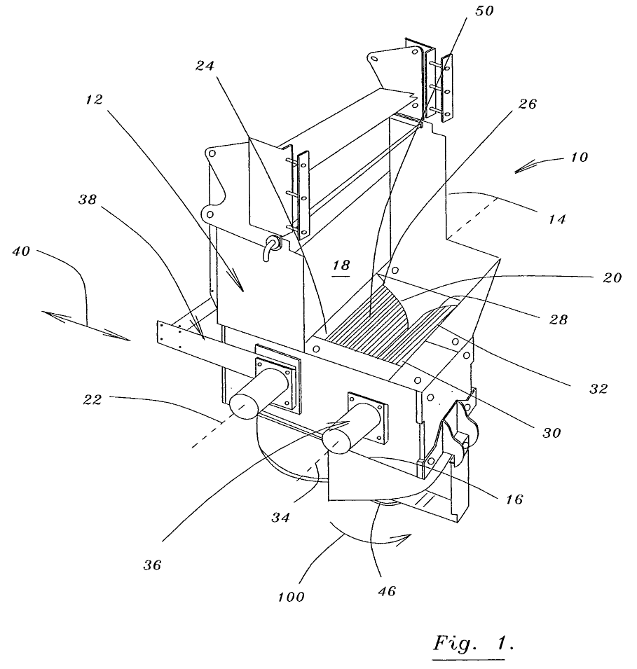

FIG. 1 is a perspective view of an apparatus generally designated 10 according to the present invention for mixing salt with a liquid to generate a salt slurry for spreading on a road surface for snow and ice control. As shown in FIG. 1, the apparatus 10 includes a chute generally designated 12 having an inlet 14 and an outlet 16, the inlet 14 receiving therein the salt. The chute 12 defines a passageway 18 which is disposed between the inlet 14 and the outlet 16. A first roller 20 is disposed adjacent to the outlet 16 of the chute 12, the first roller 20 having an axis of rotation 22 and a first and a second end 24 and 26 respectively. A second roller 28 has a first and second extremity 30 and 32 respectively, the second roller 28 being disposed adjacent to the outlet 16 of the chute 12. The second roller 28 has a rotational axis 34 which is disposed parallel to the axis of rotation 22 of the first roller 20. The rollers 20 and 28 cooperate with each other so that the chute 12 guides the salt between the rollers 20 and 28. An arrangement generally designated 36 is provided for rotating the rollers 20 and 28 relative to each other such that when the salt is guided between the rotating rollers 20 and 28, crushing of the salt is permitted. Also, a device generally designated 38 is provided for selectively moving the axes 22 and 34 of the rollers 20 and 28 towards and away from each other as indicated by the arrow 40 such that when the rollers 20 and 28 are rotated relative to each other, the crushing of the salt is controlled.

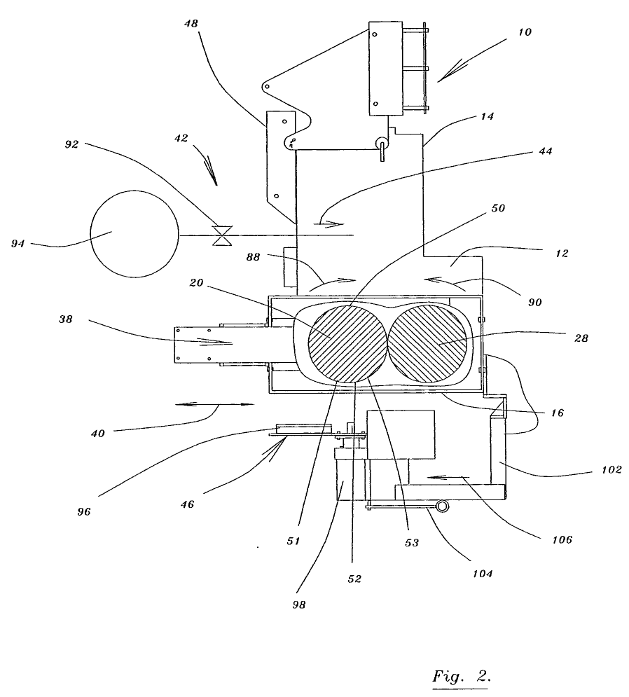

FIG. 2 is a side elevational view partially in section of the apparatus 10 shown in FIG. 1. As shown in FIG. 2, a control device generally designated 42 selectively controls a flow, as indicated by the arrow 44, of the liquid into the chute 12 so that the liquid mixes with the salt for generating the salt slurry. A rotatable spinner generally designated 46 is disposed below the rollers 20 and 28 for receiving and spreading the generated salt slurry on the road surface.

In a more specific embodiment of the present invention, an arm 48 is provided for removably securing the apparatus 10 to a snow and ice control vehicle.

As shown in FIG. 1, the passageway 18 is of rectangular cross-sectional configuration.

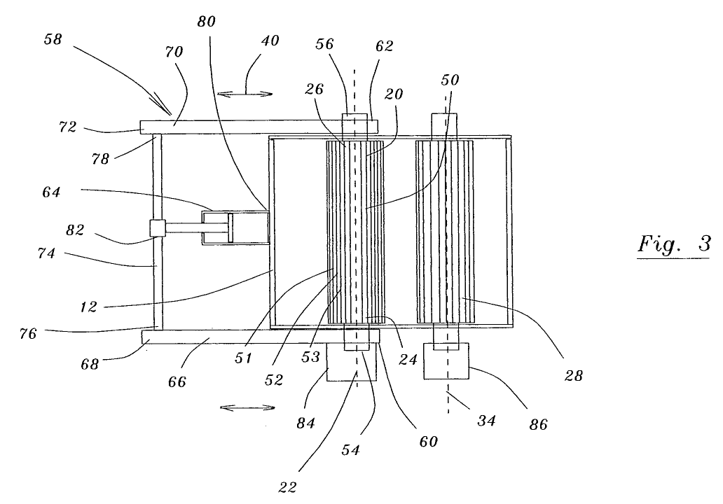

FIG. 3 is a top plan view partially in section of the apparatus 10 shown in FIGS. 1 and 2. As shown in FIG. 3, the first roller 20 has a peripheral surface 50 which extends between the first and second end 24 and 26 respectively of the first roller 20. The surface 50 defines a plurality of serrations 51, 52 and 53 which extend parallel to the axis of rotation 22.

Additionally, the first end 24 of the first roller 20 defines a first journal 54 and the second end 26 of the first roller 20 defines a second journal 56. A frame generally designated 58 has a first and second termination 60 and 62 respectively. The first termination 60 rotatably supports the first journal 54 while the second termination 62 rotatably supports the second journal 56.

An actuator 64 extends between the frame 58 and the chute 12 for controllably moving the frame 58 and the first roller 20 rotatably supported by the frame 58 relative to the chute 12.

Also, the frame 58 is of U-shaped configuration. The frame 58 includes a first arm 66 having the first termination 60 and an extension 68. A second arm 70 has the second termination 62 and a further extension 72. A cross-member 74 has a first and a second end 76 and 78 respectively, the first end 76 of the cross-member 74 being secured to the extension 68. The second end 78 of the cross-member 74 is secured to the further extension 72.

The actuator 64 has a first and a second extremity 80 and 82 respectively. The first extremity 80 of the actuator 64 is secured to the chute 12 and the second extremity 82 of the actuator 64 is secured to the cross member 74 between the ends 76 and 78 thereof.

In a preferred embodiment of the present invention, the actuator 64 is an air cylinder.

The arrangement 36 for rotating the rollers 20 and 28 includes a first motor 84 which is connected to the first roller 20 for rotating the first roller 20 about the axis of rotation 22.

Moreover, a second motor 86 is connected to the second roller 28 for rotating the second roller 28 about the rotational axis 34.

The first and second motors 84 and 86 respectively are arranged such that the first roller 20 rotates slightly faster than the second roller 28.

Furthermore, as shown in FIG. 2, the rollers 20 and 28 counter-rotate relative to each other as indicated by the arrows 88 and 90.

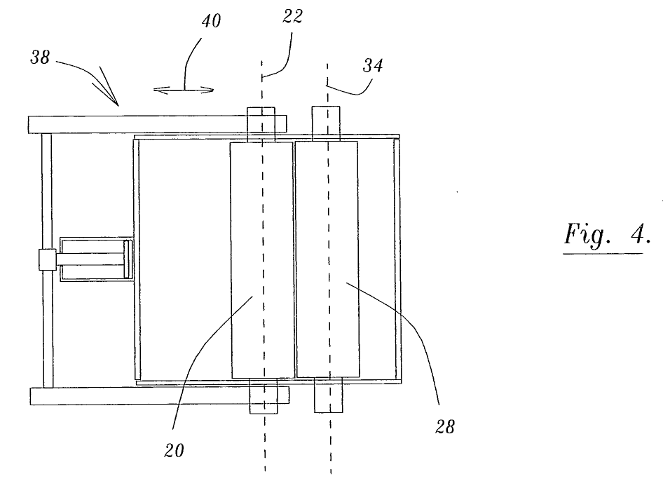

FIG. 4 is a similar view to that shown in FIG. 3 but shows the roller 20 moved towards the roller 28. As shown in FIG. 4, the device 38 selectively moves the axes 22 and 34 of the rollers 20 and 28 relative to each other as indicated by the arrow 40.

As shown in FIG. 2, the control device 42 for selectively controlling the flow 44 of the liquid into the chute 12 is a valve 92 which is disposed between a source 94 of the liquid and the chute 12 so that the flow 44 of the liquid into the chute 12 for mixing thereof with the salt is controlled.

Also, the spinner 46 includes a rotatable slurry dispenser 96. A drive 98 is drivingly connected to the dispenser 96 for rotating the dispenser 96 as indicated by the arrow 100 shown in FIG. 1.

As shown in FIG. 2, a support 102 is secured to the chute 12 for supporting the drive 98 and the dispenser 96.

Moreover, an adjuster 104 is disposed between the support 102 and the drive 98 such that controlled movement of the dispenser 96 as indicated by the arrow 106 relative to the chute 12 is permitted so that a spread pattern of the salt slurry dispensed by the dispenser 96 is attained.

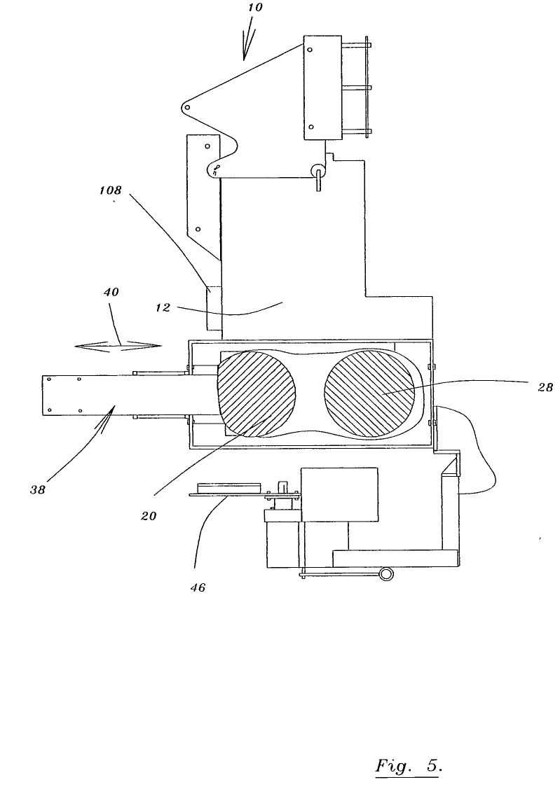

FIG. 5 is a similar view to that shown in FIG. 2 but shows the rollers 20 and 28 moved away from each other. As shown in FIG. 5, uncrushed salt is able to flow through the chute 12 onto the spinner 46 without any crushing of the salt. Also, as shown in FIG. 5, an electronic control box 108 is secured to the front side of the chute 12. The control box 108 controls the salt to liquid ratio, the degree of crushing of the salt, the discharge rate of the salt slurry by the spinner and the spread pattern.

In operation of the apparatus according to the present invention, salt is loaded into the inlet 14 of the chute 12. The salt flows through the passageway 18 and is mixed with the liquid through the adjustment of the valve 92. The salt mixed with the liquid is crushed during movement thereof between the counter-rotating rollers 20 and 28. The amount of crushing of the salt will depend on the relative disposition of the movable roller 20 relative to the fixed roller 28. The roller 20 is movable by the application of air pressure to the air actuator 64. An air actuator 64 is preferred because air is compressible whereas hydraulic fluid is not. In case a non crushable contaminant flows with the salt between the rollers, the air actuator 64 will permit the rollers to move apart so that the non crushable contaminant can pass between the rollers without damaging the rollers. Preferably, the mixture includes 30% salt and 70% liquid. However, by means of the valve 92, the flow of liquid can be adjusted. Also, by adjusting the air pressure to the actuator 64, the crushing of the salt can be adjusted between no crushing and crushing of the salt to powdered form. The amount of liquid, the amount of crushing of the salt, the speed of the spinner 46 and the disposition of the spinner relative to the flow of salt slurry generated by the rollers 20 and 28 is controlled by the electronic control box 108 so that the salt slurry is automatically dispensed at an optimum salt to liquid ratio, an optimum degree of crushing, an optimum discharge rate and an optimum spread pattern. However, the control box 108 is electrically connected to the vehicle cab so that the aforementioned requirements can be manually controlled.

The present invention provides a unique apparatus which is able to be mounted on a snow and ice control vehicle so that the apparatus generates a salt slurry for direct application onto a road surface.

What is claimed is:

1. An apparatus for mixing salt with a liquid to generate a salt slurry for spreading on a road surface for snow and ice control, said apparatus comprising:
a chute having an inlet and an outlet, said inlet receiving therein the salt, said chute defining a passageway disposed between said inlet and said outlet;
a first roller disposed adjacent to said outlet of said chute, said first roller having an axis of rotation and a first and a second end;
a second roller having a first and second extremity, said second roller being disposed adjacent to said outlet of said chute, said second roller having a rotational axis which is disposed parallel to said axis of rotation of said first roller, said rollers cooperating with each other so that said chute guides the salt between said rollers;
an arrangement for rotating said rollers relative to each other such that when the salt is guided between said rotating rollers, crushing of the salt is permitted;
a device for selectively moving said axes of said rollers towards and away from each other such that when said rollers are rotated relative to each other said crushing of the salt is controlled;
a control device for selectively controlling a flow of the liquid into said chute so that the liquid mixes with the salt for generating the salt slurry; and
a rotatable spinner disposed below said rollers for receiving and spreading the generated salt slurry on the road surface.

2. An apparatus for mixing salt with a liquid as set forth in claim 1 wherein said chute further includes:
an arm for removably securing said apparatus to a snow and ice control vehicle.

3. An apparatus for mixing salt with a liquid as set forth in claim 1 wherein said passageway is of rectangular cross-sectional configuration.

4. An apparatus for mixing salt with a liquid as set forth in claim 1 wherein
said first roller has a peripheral surface extending between said first and second end of said first roller, said surface defining a plurality of serrations extending parallel to said axis of rotation.

5. An apparatus for mixing salt with a liquid as set forth in claim 1 wherein
said first end of said first roller defines a first journal;
said second end of said first roller defines a second journal;
a frame having a first and second termination, said first termination rotatably supporting said first journal, said second termination rotatably supporting said second journal;
an actuator extending between said frame and said chute for controllably moving said frame and said first roller rotatably supported by said frame relative to said chute.

6. An apparatus for mixing salt with a liquid as set forth in claim 5 wherein
said frame is of U-shaped configuration, said frame including:
a first arm having said first termination and an extension;
a second arm having said second termination and a further extension;
a cross-member having a first and a second end, said first end of said cross-member being secured to said extension, said second end of said cross-member being secured to said further extension;
said actuator having a first and a second extremity, said first extremity of said actuator being secured to said chute, said second extremity of said actuator being secured to said cross member between said ends thereof.

7. An apparatus for mixing salt with a liquid as set forth in claim 5 wherein
said actuator is an air cylinder.

8. An apparatus for mixing salt with a liquid as set forth in claim 1 wherein
said arrangement for rotating said rollers includes:
a first motor connected to said first roller for rotating said first roller about said axis of rotation;
a second motor connected to said second roller for rotating said second roller about said rotational axis.

9. An apparatus for mixing salt with a liquid as set forth in claim 8 wherein
said first and second motors are arranged such that said first roller rotates slightly faster than said second roller.

10. An apparatus for mixing salt with a liquid as set forth in claim 8 wherein
said rollers counter-rotate relative to each other.

11. An apparatus for mixing salt with a liquid as set forth in claim 1 wherein
said device for selectively moving said axes of said rollers relative to each other is an air cylinder for moving said first roller towards and away from said second roller.

12. An apparatus for mixing salt with a liquid as set forth in claim 1 wherein
said control device for selectively controlling the flow of the liquid into said chute includes:
a valve disposed between a source of the liquid and said chute so that a flow of the liquid into said chute for mixing thereof with the salt is controlled.

13. An apparatus for mixing salt with a liquid as set forth in claim 1 wherein
said spinner includes:
a rotatable slurry dispenser;
a drive drivingly connected to said dispenser for rotating said dispenser;
a support secured to said chute, said support supporting said drive and said dispenser;
an adjuster disposed between said support and said drive such that controlled movement of said dispenser relative to said chute is permitted so that a spread pattern of the salt slurry dispensed by said dispenser is attained.

14. An apparatus for mixing salt with a liquid to generate a salt slurry for spreading on a road surface for snow and ice control, said apparatus comprising:
a chute having an inlet and an outlet, said inlet receiving therein the salt, said chute defining a passageway disposed between said inlet and said outlet;
a first roller disposed adjacent to said outlet of said chute, said first roller having an axis of rotation and a first and a second end;
a second roller having a first and second extremity, said second roller being disposed adjacent to said outlet of said chute, said second roller having a rotational axis which is disposed parallel to said axis of rotation of said first roller, said rollers cooperating with each other so that said chute guides the salt between said rollers;
an arrangement for rotating said rollers relative to each other such that when the salt is guided between said rotating rollers, crushing of the salt is permitted;
a device for selectively moving said axes of said rollers towards and away from each other such that when said rollers are rotated relative to each other said crushing of the salt is controlled;
a control device for selectively controlling a flow of the liquid into said chute so that the liquid mixes with the salt for generating the salt slurry;
a rotatable spinner disposed below said rollers for receiving and spreading the generated salt slurry on the road surface; and
said device for selectively moving said axes of said rollers towards and away from each other including:
an air cylinder.

15. An apparatus for mixing salt with a liquid to generate a salt slurry for spreading on a road surface for snow and ice control, said apparatus comprising:
a chute having an inlet and an outlet, said inlet receiving therein the salt, said chute defining a passageway disposed between said inlet and said outlet;
a first roller disposed adjacent to said outlet of said chute, said first roller having an axis of rotation and a first and a second end;
a second roller having a first and second extremity, said second roller being disposed adjacent to said outlet of said chute, said second roller having a rotational axis which is disposed parallel to said axis of rotation of said first roller, said rollers cooperating with each other so that said chute guides the salt between said rollers;
an arrangement for rotating said rollers relative to each other such that when the salt is guided between said rotating rollers, crushing of the salt is permitted;
a device for selectively moving said axes of said rollers towards and away from each other such that when said rollers are rotated relative to each other said crushing of the salt is controlled;
a control device for selectively controlling a flow of the liquid into said chute so that the liquid mixes with the salt for generating the salt slurry;
a rotatable spinner disposed below said rollers for receiving and spreading the generated salt slurry on the road surface;
said chute further including:
an arm for removably securing said apparatus to a snow and ice control vehicle;
said passageway being of rectangular cross-sectional configuration;
said first roller having a peripheral surface extending between said first and second end of said first roller, said surface defining a plurality of serrations extending parallel to said axis of rotation;
said first end of said first roller defining a first journal;
said second end of said first roller defining a second journal;
a frame having a first and second termination, said first termination rotatably supporting said first journal, said second termination rotatably supporting said second journal;
an actuator extending between said frame and said chute for controllably moving said frame and said first roller rotatably supported by said frame relative to said chute;
said frame being of U-shaped configuration, said frame including:
a first arm having said first termination and an extension;
a second arm having said second termination and a further extension;
a cross-member having a first and a second end, said first end of said cross-member being secured to said extension, said second end of said cross-member being secured to said further extension;
said actuator having a first and a second extremity, said first extremity of said actuator being secured to said chute, said second extremity of said actuator being secured to said cross member between said ends thereof;
said actuator including:
an air cylinder;
said arrangement for rotating said rollers including:
a first motor connected to said first roller for rotating said first roller about said axis of rotation;
a second motor connected to said second roller for rotating said second roller about said rotational axis;
said first and second motors being arranged such that said first roller rotates slightly faster than said second roller;
said rollers counter-rotating relative to each other;
said control device for selectively controlling the flow of the liquid into said chute including:
a valve disposed between a source of the liquid and said chute so that a flow of the liquid into said chute for mixing thereof with the salt is controlled.
said spinner including:
a rotatable slurry dispenser;
a drive drivingly connected to said dispenser for rotating said dispenser;
a support secured to said chute, said support supporting said drive and said dispenser; and
an adjuster disposed between said support and said drive such that controlled movement of said dispenser relative to said chute is permitted so that a spread pattern of the salt slurry dispensed by said dispenser is attained.
